(19) United States
(12) Patent Application Publication
(10) Pub. No.: US 2016/0292974 A1
(43) Pub. Date: Oct. 6, 2016

(54) SYSTEM AND METHOD FOR LOCATING LOST OBJECTS OR ITEMS

(71) Applicant: Yvonne Folk, Los Angeles, CA (US)

(72) Inventor: Yvonne Folk, Los Angeles, CA (US)

(21) Appl. No.: 15/089,583

(22) Filed: Apr. 3, 2016

Related U.S. Application Data
(60) Provisional application No. 62/178,112, filed on Apr. 2, 2015.

(51) Int. Cl. G08B 5/38; B65D 43/16; H04W 4/00; B65D 51/24; G08B 6/00; G08B 3/10

(52) U.S. Cl. CPC G08B 5/38; G08B 6/00; G08B 3/1016; H04W 4/008; B65D 51/245; B65D 43/165

(57) ABSTRACT

The embodiments herein provide a system and a method to locate lost/misplaced objects in a simple, economical, and cost-effective manner. The system comprises a container with an inbuilt transmitter and a plurality of buttons that activate a search signal from a transmitter when pressed. The system has a plurality of receiver strips attached to a plurality of items. The container is configured to function as a remote and a storage container. The plurality of receiver chips is configured to provide an audio alarm/alert and/or visual alarm/alert to identify or display a location of a required item attached to one of the plurality of receiver chips, when a paired locator button in the container is pressed while searching or identifying the location of the required item.

### CROSS-REFERENCE TO RELATED APPLICATION

The embodiments herein claim the priority of the U.S. Provisional Patent Application Ser. No. 62/178,112 filed on Apr. 2, 2015, with the title, “FIND IT OR LOST ITEMS”, and the content of which is included entirely as reference herein.

### BACKGROUND

1. Technical Field

The embodiments herein are generally related to a tagging and communication system and method. The embodiments herein are particularly related to a system and method for tagging good or articles of manufacture. The embodiments herein are more particularly related to a system and method for tagging good or articles of manufacture for identifying a location of hidden items or locating lost objects.

2. Description of the Related Art

A common problem faced by everyone in common is misplacing a commonly used articles/goods or losing hand-held electronic devices and other items like keys, glasses, wallet, etc. The hand-held devices being small are easily lost. Often, the items are not lost indeed, but the items are concealed/hidden by furniture or other objects, or simply misplaced in an unusual location which is difficult to trace in emergency conditions/situations or during urgency. A person takes minutes or even hours in looking for the lost item until the location is remembered. This causes frustration and loss of time for the user. In the most unfortunate cases, the items/devices are permanently lost.

The existing system for locating objects discloses a remote control having a transmitter and a receiver. The receiver has circuitry implementing power saving features. The receiver includes circuitry for turning off portions of the circuitry not essential for performing the current task. The receiver additionally activates the wireless signal receiver portion of the circuitry periodically for short periods of time only. However, the existing prior arts does not provide easily attachable receiver strips for identifying the lost/misplaced items easily and quickly.

Hence, there exists need for a simple and economical cost-effective, simple, item locator system that assists a user to find the misplaced/lost articles. Further there is a need for a misplaced goods/articles locator system provided with simple and transmitter system. Yet there is a need for a misplaced/lost articles identification system provided with beacons for providing alerts to identify the lost articles on search/demand. Yet there is a need for a misplaced/lost articles identification system provided with receivers for securing the lost articles and for notifying the location of the secured items/articles by providing visual and audio alerts/alarms. Yet there is a need for a lost article identification system provided with a container comprising inbuilt transmitter and a holder comprising receiver strips for holding articles and emitting audio or visual alarms.

The above mentioned shortcomings, disadvantages and problems are addressed herein and which will be understood by reading and studying the following specification.

### OBJECTS OF THE EMBODIMENTS

The primary object of the embodiments herein is to provide a system and a method to locate lost/misplaced objects quickly and easily.

Another object of the embodiment herein is to provide a system comprising a container with inbuilt transmitter and receiver strips for securing a plurality of articles and for providing visual and audio alerts/alarms on activation.

Yet another object of the embodiment herein is to provide a container with a built-in transmitter and a plurality of buttons for activating a search signal from a transmitter.

Yet another object of the embodiment herein is to provide a system with a plurality of receiver strips that are easily attached to a plurality of items.

Yet another object of the embodiment herein is to provide a container with a lid for securing a transmitter and a plurality of item locator buttons housing and a bottom housing for securing and storing required items.

Yet another object of the embodiment herein is to provide a container with a transmitter to act as a remote controller for locating the lost articles.

Yet another object of the embodiment herein is to provide a plurality of receiver strips with unique colour that corresponds to the plurality of locator buttons.

Yet another object of the embodiment herein is to provide a system comprising a container built in with a transmitter and a plurality of receiver items for holding a plurality of articles and for emitting audio/visual alerts/alarms upon activation.

These and other objects and advantages of the embodiments herein will become readily apparent from the following detailed description taken in conjunction with the accompanying drawings.

### SUMMARY

The following details present a simplified summary of the embodiments herein to provide a basic understanding of the several aspects of the embodiments herein. This summary is not an extensive overview of the embodiments herein. It is not intended to identify key/critical elements of the embodiments herein or to delineate the scope of the embodiments herein. Its sole purpose is to present the concepts of the embodiments herein in a simplified form as a prelude to the most detailed description that is presented later. The objects and advantages of the embodiments herein will become readily apparent from the following description taken in conjunction with the accompanying drawings.

The embodiments herein provide a system and a method to locate lost/misplaced objects. The embodiments herein provide a simple and cost-effective system and method for locating lost/misplaced objects. The system comprises a receiver for securing a plurality of articles/items/goods and a transmitter for sending a search signal to identify a lost item. The receiver is configured to release and output audio/visual alerts and alarms to identify the location of the searched item upon receiving the search signal from the transmitter.

According to an embodiment herein, a system is provided for locating lost/misplaced items. The system comprises a housing with a top lid and a bottom storage box. The housing is a container. A transmitter chip is mounted on a top surface of the container. The transmitter chip is mounted on an upper surface of the lid in the container. A plurality of locator buttons is mounted on the top surface of the container. The plurality of locator buttons chip is mounted on the upper surface of the lid in the container. The plurality of locator buttons is communicatively connected to the transmitter chip.

According to an embodiment herein, a plurality of receiver strips is paired to the plurality of locator buttons respectively. The plurality of locator buttons is configured to securely receive and hold a plurality of items/articles of manufactures. The plurality of receiver chips is configured to provide an audio alarm/alert and/or visual alarm/alert to identify or display a location of a required item attached to one of the plurality of receiver chips, when a paired locator button in the container is pressed while searching or identifying the location of the required item.

According to an embodiment herein, the paired button is pressed to activate the transmitter to transmit/broadcast a signal, and wherein the transmitted/broadcast signal is received by the paired receiver strip to output the audio alarm and/or the visual alarm.

According to an embodiment herein, the plurality of locator buttons is paired to the plurality of receiver buttons through a communication protocol. The communication protocol is selected from a group consisting of a short range wireless network, a Bluetooth communication/network, and near field communication.

According to an embodiment herein, the system further comprises an electronic circuit board housed inside the container to provide a required communication protocol.

According to an embodiment herein, the system further comprises an ON/OFF switch positioned within the housing and electrically connected to the transmitter chip.

According to an embodiment herein, the system further comprises a power supply for supplying an electrical power to the transmitter chip. The power supply is a battery/solar power/rechargeable battery.

According to an embodiment herein, the plurality of receiver strips comprises a speaker to output the audio alarm, when the corresponding locator button is pressed.

According to an embodiment herein, the plurality of receiver strips comprises an audio alarm unit to provide the audio alarm. The audio alarm is a sound or a tone or a beep sound. The audio alarm is output continuously or intermittently.

According to an embodiment herein, the plurality of receiver strips comprises a light emitting unit to provide the visual alarm. The light emitting unit is a light emitting diode (LED) or Light Crystal Display (LCD). The visual alarm is output as a continuous light emission or blinking light. A colour of the light output from the plurality of the receiver strips is mutually different to each other.

According to an embodiment herein, the plurality of receiver strips comprises a vibrator unit to provide vibrations or vibrating sound.

According to an embodiment herein, the plurality of receiver strip outputs the audio alarm and visual alarm sound until the locator button is deactivated.

According to an embodiment herein, the plurality of receiver strips comprises a fastener for receiving and holding the item. The fastener is selected from a group consisting of a hook, a clamp, a ring, a packet or pouch, a Velcro and an adhesive strip. The fastener provided in the plurality of the receiver strips for holding the item is same or different.

According to an embodiment herein, each of the plurality of receiver strips has a unique colour.

According to an embodiment herein, each of the plurality of locator buttons has a unique colour. The colour of each locator button and the colour of the paired locator button are same.

According to an embodiment herein, the top lid and the bottom storage box are coupled through a plurality of hinge pins. The bottom storage box is designed/configured to secure any desired item within.

According to an embodiment herein, the container is configured to act as a remote control unit. The container is design to be attached to any wall or any surface.

According to an embodiment herein, the item attached to the plurality of receiver strips is selected from a group consisting of keys, glasses, telephone, watch, valet, address book, remote control, and purse/wallet.

According to an embodiment herein, the container is made of injection moulded Acrylonitrile butadiene styrene (ABS).

According to an embodiment herein, a method is provided for locating items through a container and a plurality of receiver strips. The container is provided with a transmitter chip and a plurality of locator buttons communicatively connected to the transmitter chip. The method comprises attaching a receiver strip from a plurality of receiver strips to an item. Each receiver strip has a unique colour and corresponds to a colour of a paired locator button on the container. An ON/OFF switch located on the housing to energise the transmitter. One of the locator buttons corresponding to a required or lost or misplaced item is pressed to activate the transmitter chip to generate a radio signal which is broadcast to the plurality of locators. The radio signal is received by at least one receiver strip corresponding to the locator button. The receiver strip is configured to output an audio alarm and visual alarm. The audio alarm is a sound or a tone or a beep sound. The audio alarm is output continuously or intermittently. The visual alarm is output as a continuous light emission or blinking light. A colour of the light output from the plurality of the receiver strips is mutually different to each other. The receiver strip outputs the audio alarm and visual alarm sound until the locator button is deactivated.

According to an embodiment herein, the system comprises a container with an inbuilt transmitter and a plurality of receiver strips. The container further includes a plurality of buttons that activate a search signal from a transmitter when pressed. The plurality of receiver strips in the system is attached to a plurality of items. The container includes a lid for housing the transmitter and a bottom box for housing any articles of interest. The container is configured to act as a remote transmitter/controller and a storage container. A control circuit embedded on an electronic board is provided in the bottom box. The buttons provided in the transmitter and the receiver strips are communicatively paired through a communication protocol.

According to an embodiment herein, a system for locating lost items includes a container and a plurality of attachable receivers. The container includes a housing with a transmitter chip embedded on it. The container is hung on a wall or surface like refrigerator. The container further comprises a plurality of locator buttons. Each button is paired respectively with a receiver securing an item. The plurality of locator buttons is positioned on the lid of the container and communicatively coupled to the transmitter to send a search signal, when one locator button is pressed. The plurality of items is selected from a group consisting of keys, eye-glasses, mobile phone, watch, money valet, address book, remote control, and purse. The size of the locator buttons are large enough to receive a logo or label of an item. The logo or label or icon or a numeral is affixed on the locator button for identifying the paired item and for helping/aiding the visually impaired persons.

According to an embodiment herein, a transmitter chip is positioned within the housing and electrically connected to the plurality of locator buttons. Each locator button has a specific color and is paired with a respective receiver strip. The transmitter chip is further electrically connected to a first end of ON/OFF switch which is positioned within the housing. The second end of the ON/OFF switch is electrically connected to one distal end of a battery. The battery is positioned within the housing. The ON/OFF switch functions to control electrical energy from the battery.

According to an embodiment herein, a method is provided for locating items using a container provided with a transmitter and a plurality of locator buttons, and a receiver system/strips for receiving and securing an item and for providing audio/visual alarms. Each receiver strip has a unique color and is paired with a corresponding to a locator button through a short range communication protocol such as Bluetooth communication, near field communication, short range wireless network. A user switches ON the ON/OFF switch to activate the system and to power the transmitter. When an item attached to the receiver strip is lost or a lost item attached to the receiver strip is searched, the locator button paired to the receiver strip attached to the searched/lost item is pressed to activate a transmitter to send a search signal. An electrical impulse is sent to the transmitter chip which sends an electronic signal to the corresponding receiver strip, to broadcast a radio signal therefrom. The corresponding receiver strip attached to the lost item from the plurality of receiver strip receives the electrical signal or transmitted signal to output a sound alarm. Alternately the receiver strip is provided with a LED to emit a visual alarm. The LED is configured to emit a continuous light or a blinking light. The receiver strip is configured to output a sound/tone/alarm until the locator button is deactivated. Thus, the sound emitted from the receiver strip enables a user to locate the item attached to the receiver strip. The user is enabled control a volume of the receiver sound using a volume control button connected to the housing.

According to an embodiment herein, a vibrator is connected to the receiver strip. When a user activates one of the locator buttons, an electrical impulse is transmitted to the transmitter chip which sends an electronic signal to the corresponding receiver strip, broadcasting a radio signal therefrom. The corresponding receiver strip from the plurality of receiver strip receives electrical signal, and is configured to vibrate and emit a vibrating sound.

According to an embodiment herein, a light emitting diode (LED) or Light Crystal Display (LCD) is connected to at least one receiver strip. When a user activates one of the locator buttons, an electrical impulse is transmitted to the transmitter chip to send an electronic signal to the corresponding receiver strip, by broadcasting a radio signal therefrom. The corresponding receiver strip from the plurality of receiver strips receives the electrical signal, and emits a Light.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

### BRIEF DESCRIPTION OF THE DRAWINGS

The other objects, features and advantages will occur to those skilled in the art from the following description of the preferred embodiment and the accompanying drawings in which:

FIG. 1A illustrates a system for locating lost/misplaced items comprising a container assembly and a plurality of receiver strips, according to an embodiment herein.

FIG. 1B illustrates a top side view of the container and the receiver strips included in the system for locating lost/misplaced items, according to an embodiment herein.

FIG. 1C illustrates a side view of the container in the system for locating lost/misplaced items, according to an embodiment herein.

FIG. 1D illustrates a bottom view of the container in the system for locating lost/misplaced items, according to an embodiment herein.

FIG. 1E illustrates a front view of the electronic board/door housed inside the container in the system for locating lost/misplaced items, according to an embodiment herein.

FIG. 1F illustrates a side view of the electronic door in the container in the system for locating lost/misplaced items, according to an embodiment herein.

FIG. 2 illustrates a flowchart explaining a method of locating lost/misplaced items using a container and a plurality of receiver strips, according to an embodiment herein.

Although the specific features of the embodiments herein are shown in some drawings and not in others. This is done for convenience only as each feature may be combined with any or all of the other features in accordance with the embodiments herein.

### DETAILED DESCRIPTION OF THE EMBODIMENTS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The embodiments herein provide a system and a method to locate lost/misplaced objects. The embodiments herein provide a simple and cost-effective system and method for locating lost/misplaced objects. The system comprises a receiver for securing a plurality of articles/items/goods and a transmitter for sending a search signal to identify a lost item. The receiver is configured to release and output audio/visual alerts and alarms to identify the location of the searched item upon receiving the search signal from the transmitter.

According to an embodiment herein, a system is provided for locating lost/misplaced items. The system comprises a housing with a top lid and a bottom storage box. The housing is a container. A transmitter chip is mounted on a top surface of the container. The transmitter chip is mounted on an upper surface of the lid in the container. A plurality of locator buttons is mounted on the top surface of the container. The plurality of locator buttons chip is mounted on the upper surface of the lid in the container. The plurality of locator buttons is communicatively connected to the transmitter chip.

According to an embodiment herein, a plurality of receiver strips is paired to the plurality of locator buttons respectively. The plurality of locator buttons is configured to securely receive and hold a plurality of items/articles of manufactures. The plurality of receiver chips is configured to provide an audio alarm/alert and/or visual alarm/alert to identify or display a location of a required item attached to one of the plurality of receiver chips, when a paired locator button in the container is pressed while searching or identifying the location of the required item.

According to an embodiment herein, the paired button is pressed to activate the transmitter to transmit/broadcast a signal, and wherein the transmitted/broadcast signal is received by the paired receiver strip to output the audio alarm and/or the visual alarm.

According to an embodiment herein, the plurality of locator buttons is paired to the plurality of receiver buttons through a communication protocol. The communication protocol is selected from a group consisting of a short range wireless network, a Bluetooth communication/network, and near field communication.

According to an embodiment herein, the system further comprises an electronic circuit board housed inside the container to provide a required communication protocol.

According to an embodiment herein, the system further comprises an ON/OFF switch positioned within the housing and electrically connected to the transmitter chip.

According to an embodiment herein, the system further comprises a power supply for supplying an electrical power to the transmitter chip. The power supply is a battery/solar power/rechargeable battery.

According to an embodiment herein, the plurality of receiver strips comprises a speaker to output the audio alarm, when the corresponding locator button is pressed.

According to an embodiment herein, the plurality of receiver strips comprises an audio alarm unit to provide the audio alarm. The audio alarm is a sound or a tone or a beep sound. The audio alarm is output continuously or intermittently.

According to an embodiment herein, the plurality of receiver strips comprises a light emitting unit to provide the visual alarm. The light emitting unit is a light emitting diode (LED) or Light Crystal Display (LCD). The visual alarm is output as a continuous light emission or blinking light. A colour of the light output from the plurality of the receiver strips is mutually different to each other.

According to an embodiment herein, the plurality of receiver strips comprises a vibrator unit to provide vibrations or vibrating sound.

According to an embodiment herein, the plurality of receiver strip outputs the audio alarm and visual alarm sound until the locator button is deactivated.

According to an embodiment herein, the plurality of receiver strips comprises a fastener for receiving and holding the item. The fastener is selected from a group consisting of a hook, a clamp, a ring, a packet or pouch, a Velcro and an adhesive strip. The fastener provided in the plurality of the receiver strips for holding the item is same or different.

According to an embodiment herein, each of the plurality of receiver strips has a unique colour.

According to an embodiment herein, each of the plurality of locator buttons has a unique colour. The colour of each locator button and the colour of the paired locator button are same.

According to an embodiment herein, the top lid and the bottom storage box are coupled through a plurality of hinge pins. The bottom storage box is designed/configured to secure any desired item within.

According to an embodiment herein, the container is configured to act as a remote control unit. The container is design to be attached to any wall or any surface.

According to an embodiment herein, the item attached to the plurality of receiver strips is selected from a group consisting of keys, glasses, telephone, watch, valet, address book, remote control, and purse/wallet.

According to an embodiment herein, the container is made of injection moulded Acrylonitrile butadiene styrene (ABS).

According to an embodiment herein, a method is provided for locating items through a container and a plurality of receiver strips. The container is provided with a transmitter chip and a plurality of locator buttons communicatively connected to the transmitter chip. The method comprises attaching a receiver strip from a plurality of receiver strips to an item. Each receiver strip has a unique colour and corresponds to a colour of a paired locator button on the container. An ON/OFF switch located on the housing to energise the transmitter. One of the locator buttons corresponding to a required or lost or misplaced item is pressed to activate the transmitter chip to generate a radio signal which is broadcast to the plurality of locators. The radio signal is received by at least one receiver strip corresponding to the locator button. The receiver strip is configured to output an audio alarm and visual alarm. The audio alarm is a sound or a tone or a beep sound. The audio alarm is output continuously or intermittently. The visual alarm is output as a continuous light emission or blinking light. A colour of the light output from the plurality of the receiver strips is mutually different to each other. The receiver strip outputs the audio alarm and visual alarm sound until the locator button is deactivated.

According to an embodiment herein, the system comprises a container with an inbuilt transmitter and a plurality of receiver strips. The container further includes a plurality of buttons that activate a search signal from a transmitter when pressed. The plurality of receiver strips in the system is attached to a plurality of items. The container includes a lid for housing the transmitter and a bottom box for housing any articles of interest. The container is configured to act as a remote transmitter/controller and a storage container. A control circuit embedded on an electronic board is provided in the bottom box. The buttons provided in the transmitter and the receiver strips are communicatively paired through a communication protocol.

According to an embodiment herein, a system for locating lost items includes a container and a plurality of attachable receivers. The container includes a housing with a transmitter chip embedded on it. The container is hung on a wall or surface like refrigerator. The container further comprises a plurality of locator buttons. Each button is paired respectively with a receiver securing an item. The plurality of locator buttons is positioned on the lid of the container and communicatively coupled to the transmitter to send a search signal, when one locator button is pressed. The plurality of items is selected from a group consisting of keys, eye-glasses, mobile phone, watch, money valet, address book, remote control, and purse. The size of the locator buttons are large enough to receive a logo or label of an item. The logo or label or icon or a numeral is affixed on the locator button for identifying the paired item and for helping/aiding the visually impaired persons.

According to an embodiment herein, a transmitter chip is positioned within the housing and electrically connected to the plurality of locator buttons. Each locator button has a specific color and is paired with a respective receiver strip. The transmitter chip is further electrically connected to a first end of ON/OFF switch which is positioned within the housing. The second end of the ON/OFF switch is electrically connected to one distal end of a battery. The battery is positioned within the housing. The ON/OFF switch functions to control electrical energy from the battery.

According to an embodiment herein, a method is provided for locating items using a container provided with a transmitter and a plurality of locator buttons, and a receiver system/strips for receiving and securing an item and for providing audio/visual alarms. Each receiver strip has a unique color and is paired with a corresponding to a locator button through a short range communication protocol such as Bluetooth communication, near field communication, short range wireless network. A user switches ON the ON/OFF switch to activate the system and to power the transmitter. When an item attached to the receiver strip is lost or a lost item attached to the receiver strip is searched, the locator button paired to the receiver strip attached to the searched/lost item is pressed to activate a transmitter to send a search signal. An electrical impulse is sent to the transmitter chip which sends an electronic signal to the corresponding receiver strip, to broadcast a radio signal therefrom. The corresponding receiver strip attached to the lost item from the plurality of receiver strip receives the electrical signal or transmitted signal to output a sound alarm. Alternately the receiver strip is provided with a LED to emit a visual alarm. The LED is configured to emit a continuous light or a blinking light. The receiver strip is configured to output a sound/tone/alarm until the locator button is deactivated. Thus, the sound emitted from the receiver strip enables a user to locate the item attached to the receiver strip. The user is enabled control a volume of the receiver sound using a volume control button connected to the housing.

According to an embodiment herein, a vibrator is connected to the receiver strip. When a user activates one of the locator buttons, an electrical impulse is transmitted to the transmitter chip which sends an electronic signal to the corresponding receiver strip, broadcasting a radio signal therefrom. The corresponding receiver strip from the plurality of receiver strip receives electrical signal, and is configured to vibrate and emit a vibrating sound.

According to an embodiment herein, a light emitting diode (LED) or Light Crystal Display (LCD) is connected to at least one receiver strip. When a user activates one of the locator buttons, an electrical impulse is transmitted to the transmitter chip to send an electronic signal to the corresponding receiver strip, by broadcasting a radio signal therefrom. The corresponding receiver strip from the plurality of receiver strips receives the electrical signal, and emits a Light.

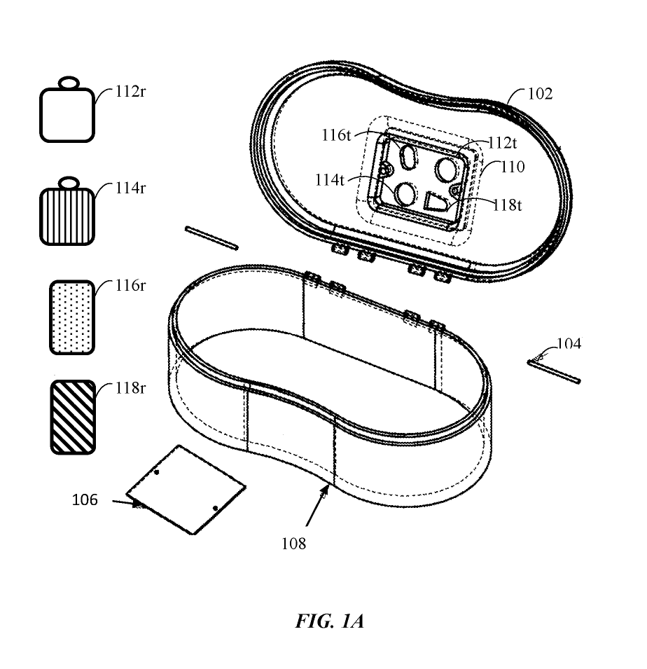

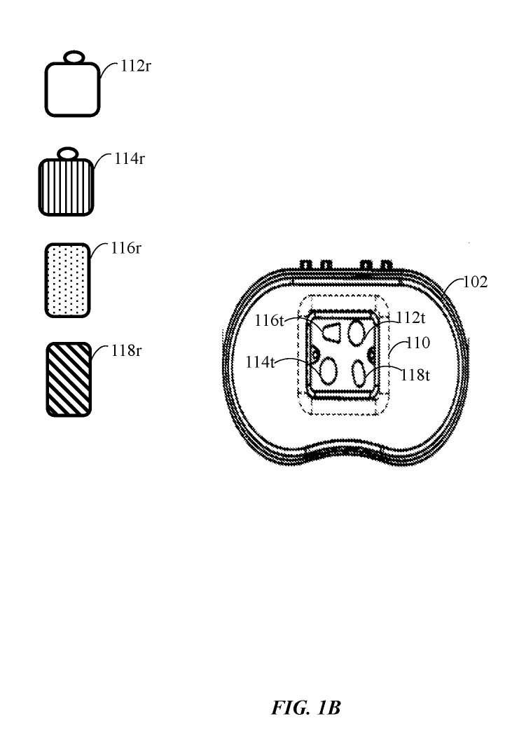

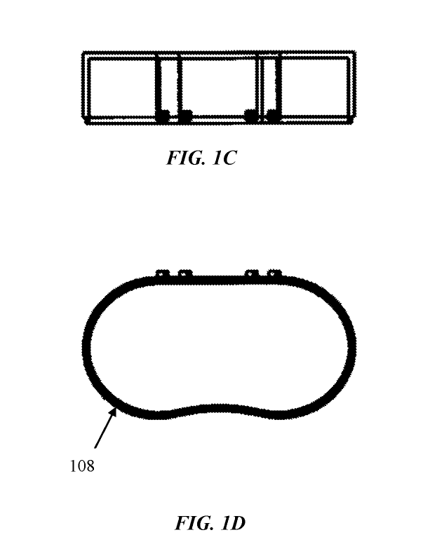

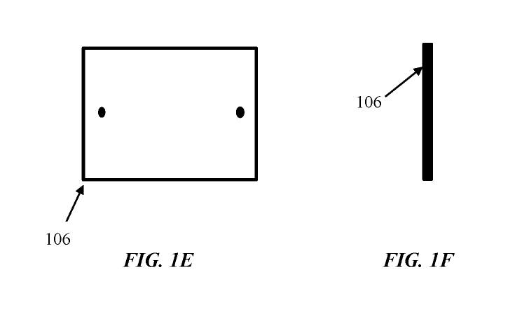

FIG. 1A illustrates a system for locating lost/misplaced items comprising a container assembly and a plurality of receiver strips, according to an embodiment herein. FIG. 1B illustrates a top side view of the container and the receiver strips included in the system for locating lost/misplaced items, according to an embodiment herein. FIG. 1C illustrates a side view of the container in the system for locating lost/misplaced items, according to an embodiment herein. FIG. 1D illustrates a bottom view of the container in the system for locating lost/misplaced items, according to an embodiment herein. FIG. 1E illustrates a front view of the electronic board/door housed inside the container in the system for locating lost/misplaced items, according to an embodiment herein. FIG. 1F illustrates a side view of the electronic door in the container in the system for locating lost/misplaced items, according to an embodiment herein.

With respect to FIG. 1A-FIG. 1F, the system comprises the container built in with a transmitter 110 and the plurality of locator buttons 112t, 114t, 116t, 118t respectively paired to the plurality of receiver strips 112r, 114r, 116r, 118r. The container has a bottom box 108 and the lid 102. The bottom box 108 is configured to house an electronic board 106. The bottom box is configured to act as a storage box for storing and securing any desired vehicle. The lid 102 is connected to the box 108 through a plurality of hinge pins 104. The lid 102 is embedded with a transmitter chip 110. Further, a plurality of locator buttons 112t, 114t, 116t, 118t is embedded on the top surface of the lid and electrically connected to the transmitter chip 110. Furthermore, the container includes an electronic door 106 and a hinge pin 104 connecting the lid of the housing with the bottom box of the housing. The plurality of locator buttons 112t, 114t, 116t, 118t is respectively paired to the plurality of receiver strips 112r, 114r, 116r, 118r provided to securely hold a corresponding item. The plurality of locator buttons 112t, 114t, 116t, 118t is respectively paired to the plurality of receiver strips 112r, 114r, 116r, 118r through a short range communication protocol. The short range communication protocol includes a Bluetooth communication, near filed communication, a short range communication, etc. The plurality of locator buttons are positioned and mounted on the top surface of the lid. The items are selected from a group consisting of keys, glasses, telephone, watch, valet, address book, remote control, and purse/wallet. The locator buttons are large enough to have a large icon of the item paired thereon. The size of the locator buttons are large enough to receive a logo or label of an item. The logo or label or icon or a numeral is affixed on the locator button for identifying the paired item and for helping/aiding the visually impaired persons.

Each receiver strip is provided with a hook or clamp or ring to securely receive and hold an article of item. Each receiver strip is provided with an adhesive strip or packet to receive and hold the items. Each receiver strip is provided with individual color for easy identification of each item attached to the receiver strip. The items are selected from a group consisting of keys, glasses, telephone, watch, valet, address book, remote control, and purse/wallet. Each receiver strip is provided with a buzzer for emitting sound or a bulb for emitting a light or a vibrator to emit vibrations/vibrating sound.

According to an embodiment herein, the system comprises the plurality of receiver strips 112r, 114r, 116r, and 118r that are attachable to a plurality of items. Each locator button has a specific color and corresponds to at least one of the receiver strip. The container further comprises an ON/OFF switch which is positioned within the housing, wherein a first end of the ON/OFF switch is electrically connected to the transmitter chip 110. The container further comprises a battery positioned within the housing, which is electrically connected to a second end of the ON/OFF. The ON/OFF switch functions to control electrical energy from the battery.

According to an embodiment herein, the housing of the container is made of injection molded Acrylonitrile butadiene styrene (ABS). The electronic door 106 is composed of injection molded aluminum. The hinge pin 104 is composed of steel.

According to an embodiment herein, a vibrator is connected to the receiver strip. When a user activates one of the locator buttons, an electrical impulse is transmitted to the transmitter chip which sends an electronic signal to the corresponding receiver strip, broadcasting a radio signal therefrom. The corresponding receiver strip from the plurality of receiver strip receives electrical signal, and is configured to vibrate and emit a vibrating sound.

According to an embodiment herein, a light emitting diode (LED) or Light Crystal Display (LCD) is connected to at least one receiver strip. When a user activates one of the locator buttons, an electrical impulse is transmitted to the transmitter chip to send an electronic signal to the corresponding receiver strip, by broadcasting a radio signal therefrom. The corresponding receiver strip from the plurality of receiver strips receives the electrical signal, and emits a Light.

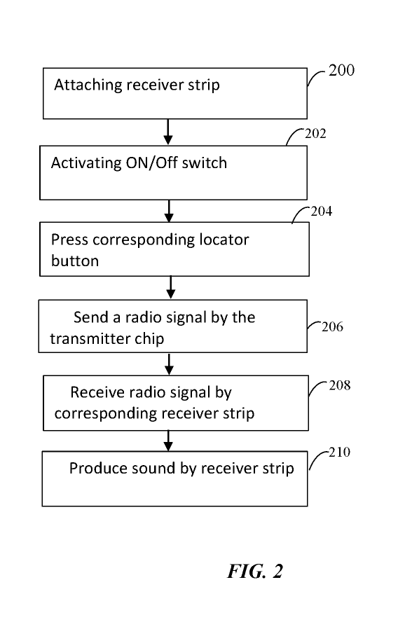

FIG. 2 illustrates a flowchart explaining a method of locating items using a container and a plurality of receiver strips. The container is provided with a built in transmitter chip and a plurality of locator buttons embedded on the surface of the lid, and a plurality or receiver chip with a capability to emit audio/visual alarm/alert to indicate a lost/misplaced item upon activation. The method involves attaching a receiver strip from at a plurality of receiver strips to an item (202). Each receiver strip has a unique color and corresponds to a locator button on the container. Each receiver strip is paired to a corresponding to a locator button on the container A user activates an ON the ON/OFF switch (204). When an item is lost or misplaced or searched, the user presses a respective locator button corresponding to the lost item (206). An electrical impulse is sent to the transmitter chip which sends an electronic signal to the corresponding receiver strip, by broadcasting a radio signal therefrom (208). The corresponding receiver strip attached to the lost item from the plurality of receiver strip receives the transmitted electrical signal, and outputs sound (210). The receiver strip outputs a sound until the locator button is deactivated. Thus, the sound enables a user to locate the item attached to the receiver strip. The user is enabled to control volume of the receiver sound using a volume control button connected to the housing.

According to an embodiment herein, a vibrator is connected to the receiver strip. When a user activates one of the locator buttons, an electrical impulse is transmitted to the transmitter chip which sends an electronic signal to the corresponding receiver strip, broadcasting a radio signal therefrom. The corresponding receiver strip from the plurality of receiver strip receives electrical signal, and is configured to vibrate and emit a vibrating sound.

According to an embodiment herein, a light emitting diode (LED) or Light Crystal Display (LCD) is connected to at least one receiver strip. When a user activates one of the locator buttons, an electrical impulse is transmitted to the transmitter chip to send an electronic signal to the corresponding receiver strip, by broadcasting a radio signal therefrom. The corresponding receiver strip from the plurality of receiver strips receives the electrical signal, and emits a Light.

Advantageously, the embodiments herein provide a simple and cost-effective system for locating lost objects. The system comprises a container with an inbuilt transmitter and a plurality of receiver strips. The container includes a plurality of buttons that activate a search signal from a transmitter when pressed. The plurality of receiver strips in the system is attached to a plurality of items. The container includes a lid and a box that are configured to function as a remote controller and a storage container. The locator buttons are provided to secure and locate the items selected from a group consisting of keys, glasses, telephone, watch, money, address book, a remote controller, and purse/wallet The locator buttons are large, each having a large icon of the item positioned thereon which facilitates location by visually impaired persons.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. A system for locating lost/misplaced items, the system comprising:
a housing with a top lid and a bottom storage box, and wherein the housing is a container;
a transmitter chip mounted on a top surface of the container, and wherein the transmitter chip is mounted on an upper surface of the lid in the container;
a plurality of locator buttons mounted on the top surface of the container, and wherein the plurality of locator buttons chip is mounted on the upper surface of the lid in the container, and wherein the plurality of locator buttons is communicatively connected to the transmitter chip;
a plurality of receivers strips paired to the plurality of locator buttons, and wherein the plurality of locator buttons is configured to securely receive and hold a plurality of items/articles of manufactures;
wherein the plurality of receiver chips is configured to provide an audio alarm/alert and/or visual alarm/alert to identify or display a location of a required item attached to one of the plurality of receiver chips, when a paired locator button in the container is pressed while searching or identifying the location of the required item.

2. The system according to claim 1, wherein the paired button is pressed to activate the transmitter to transmit/broadcast a signal, and wherein the transmitted/broadcast signal is received by the paired receiver strip to output the audio alarm and/or the visual alarm.

3. The system according to claim 1, wherein the plurality of locator buttons is paired to the plurality of receiver buttons respectively through a communication protocol, and wherein the communication protocol is selected from a group consisting of a short range wireless network, a Bluetooth communication/network, and near field communication.

4. The system according to claim 1, further comprises an electronic circuit board housed inside the container to provide a required communication protocol.

5. The system according to claim 1, further comprises an ON/OFF switch positioned within the housing and electrically connected to the transmitter chip.

6. The system according to claim 1, further comprises a power supply for supplying an electrical power to the transmitter chip, and wherein the power supply is a battery/solar power/rechargeable battery.

7. The system according to claim 1, wherein the plurality of receiver strips comprises a speaker to output the audio alarm, when the corresponding locator button is pressed.

8. The system according to claim 1, wherein the plurality of receiver strips comprises an audio alarm unit to provide the audio alarm, and wherein the audio alarm is a sound or a tone or a beep sound, and wherein the audio alarm is output continuously or intermittently.

9. The system according to claim 1, wherein the plurality of receiver strips comprises a light emitting unit to provide the visual alarm, and wherein the light emitting unit is a light emitting diode (LED) or Light Crystal Display (LCD), and wherein the visual alarm is output as a continuous light emission or blinking light, and wherein a colour of the light output from the plurality of the receiver strips is mutually different to each other.

10. The system according to claim 1, wherein the plurality of receiver strips comprises a vibrator unit to provide vibrations or vibrating sound.

11. The system according to claim 1, wherein the plurality of receiver strips is configured to output the audio alarm and visual alarm sound until the locator button is deactivated.

12. The system according to claim 1, wherein the plurality of receiver strips comprises a a fastener for receiving and holding the item, and wherein the fastener is selected from a group consisting of a hook, a clamp, a ring, a packet or pouch, a Velcro and an adhesive strip, and wherein the fastener provided in the plurality of the receiver strips for holding the item is same or different.

13. The system according to claim 1, wherein each of the plurality of receiver strips has a unique colour.

14. The system according to claim 1, wherein each of the plurality of locator buttons has a unique colour, and wherein the colour of each locator button and the colour of the paired locator button are same.

15. The system according to claim 1, wherein the top lid and the bottom storage box are coupled through a plurality of hinge pins, and wherein the bottom storage box is designed/configured to secure any desired item within.

16. The system according to claim 1, wherein the container is configured to act as a remote control unit, and wherein the container is designed/configured to be attached to any wall or any surface.

17. The system according to claim 1, wherein the item attached to the plurality of receiver strips is selected from a group consisting of keys, glasses, telephone, watch, valet, address book, remote control, and purse/wallet.

18. The system according to claim 1, wherein the container is made of injection moulded Acrylonitrile butadiene styrene (ABS).

19. A method of locating items through a container and a plurality of receiver strips, wherein the container is provided with a transmitter chip and a plurality of locator buttons communicatively connected to the transmitter chip, the method comprises:
attaching a receiver strip from a plurality of receiver strips to an item, wherein each receiver strip has a unique colour and corresponds to a colour of a paired locator button on the container;
activating an ON/OFF switch located on the housing;
pressing one of the locator buttons corresponding to a required or lost or misplaced item;
activating the transmitter chip to generate a radio signal, wherein the radio signal is broadcast;
receiving the radio signal by at least one receiver strip corresponding to the locator button, and wherein the receiver strip is configured to output an audio alarm and visual alarm, and wherein the audio alarm is a sound or a tone or a beep sound, and wherein the audio alarm is output continuously or intermittently, and wherein the visual alarm is output as a continuous light emission or blinking light, and wherein a colour of the light output from the plurality of the receiver strips is mutually different to each other.

20. The method according to claim 19, wherein the receiver strip outputs the audio alarm and visual alarm sound until the locator button is deactivated.
